(19) United States
(12) Patent Application Publication
(10) Pub. No.: US 2023/0124612 A1
(43) Pub. Date: Apr. 20, 2023

(54) CONTROL DEVICE AND CONTROL METHOD

(71) Applicant: KABUSHIKI KAISHA TOKAI RIKA DENKI SEISAKUSHO, Aichi (JP)

(72) Inventors: Masateru FURUTA, Aichi (JP); Shigenori NITTA, Aichi (JP); Yuki KONO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/914,458

(22) PCT Filed: Feb. 4, 2021
(86) PCT No.: PCT/JP2021/004009

§ 371 Date: Sep. 26, 2022

(30) Foreign Application Priority Data
Apr. 6, 2020 (JP) 2020-068667

(51) Int. Cl. G06F 21/44; B60R 25/24; G06F 21/43

(52) U.S. Cl. CPC G06F 21/44; B60R 25/24; G06F 21/43

(57) ABSTRACT

To provide a control device and control method that make it possible to reduce inter-device authentication failure.

Provided is a control device including a control section configured to execute an authentication process of authenticating another device on the basis of information for authentication acquired from the other device. The control section starts the execution of the authentication process in the case where a predetermined trigger is acquired.

### TECHNICAL FIELD

The present invention relates to a control device and a control method.

### BACKGROUND ART

In recent years, technologies of authenticating a device in accordance with a result of transmitting/receiving signals between devices have been developed. For example, Patent Literature 1 listed below discloses a vehicle control system of authenticating a portable device by transmitting/receiving signals between an in-vehicle device and the portable device. The portable device is carried by a user, and the in-vehicle device is installed in the vehicle. Such a vehicle control system controls vehicle behavior such as unlocking doors of the vehicle or starting an engine when the portable device is successfully authenticated.

### CITATION LIST

### Patent Literature

Patent Literature 1: JP H11-208419A

### DISCLOSURE OF INVENTION

### Technical Problem

However, Patent Literature 1 has caused inconvenience because subsequent behavior such as behavior control is not performed when the inter-device authentication has failed.

Accordingly, the present invention is made in view of the aforementioned problem, and an object of the present invention is to provide a novel and improved control device and control method that make it possible to reduce inter-device authentication failure.

### Solution to Problem

According to an aspect of the present invention, there is provided a control device comprising a control section configured to execute an authentication process of authenticating another device on a basis of information for authentication acquired from the other device, wherein, the control section starts the execution of the authentication process in a case where a predetermined trigger is acquired.

According to other aspect of the present invention, there is provided a control device comprising a control section configured to perform control in such a manner that information to be used by another device to perform authentication is output to the other device, wherein, in a case where a predetermined trigger is acquired, the control section performs control in such a manner that the information is output to the other device that starts execution of an authentication process of authenticating the control device.

According to other aspect of the present invention, there is provided a control method comprising causing a processor to execute an authentication process of authenticating another device on a basis of information for authentication acquired from the other device, wherein the execution of the authentication process is started in a case where a predetermined trigger is acquired.

According to other aspect of the present invention, there is provided a control method comprising causing a processor to perform control in such a manner that information to be used by another device to perform authentication is output to the other device, wherein, the output control is performed with regard to the other device that starts execution of an authentication process of authenticating the control device in a case where a predetermined trigger is acquired.

### Advantageous Effects of Invention

As described above, according to the present invention, it is possible to reduce inter-device authentication failure.

### BRIEF DESCRIPTION OF DRAWINGS

FIG. 1 is a diagram illustrating an example of a configuration of a system according to an embodiment of the present invention.

FIG. 2 is a sequence diagram illustrating an example of a flow of an authentication process performed by the system according to the embodiment.

FIG. 3 is a diagram illustrating an example of a configuration of a system according to an application example of the present invention.

FIG. 4 is a sequence diagram illustrating an example of a flow of an authentication process performed by the system according to the application example of the present invention.

FIG. 5 is a sequence diagram illustrating another example of the flow of the authentication process performed by the system according to the application example of the present invention.

### MODE(S) FOR CARRYING OUT THE INVENTION

Hereinafter, referring to the appended drawings, preferable embodiments of the present invention will be described in detail. Note that, in this specification and the appended drawings, structural elements that have substantially the same function and structure are denoted with the same reference signs, and repeated explanation of these structural elements will be omitted.

### 1. Overview

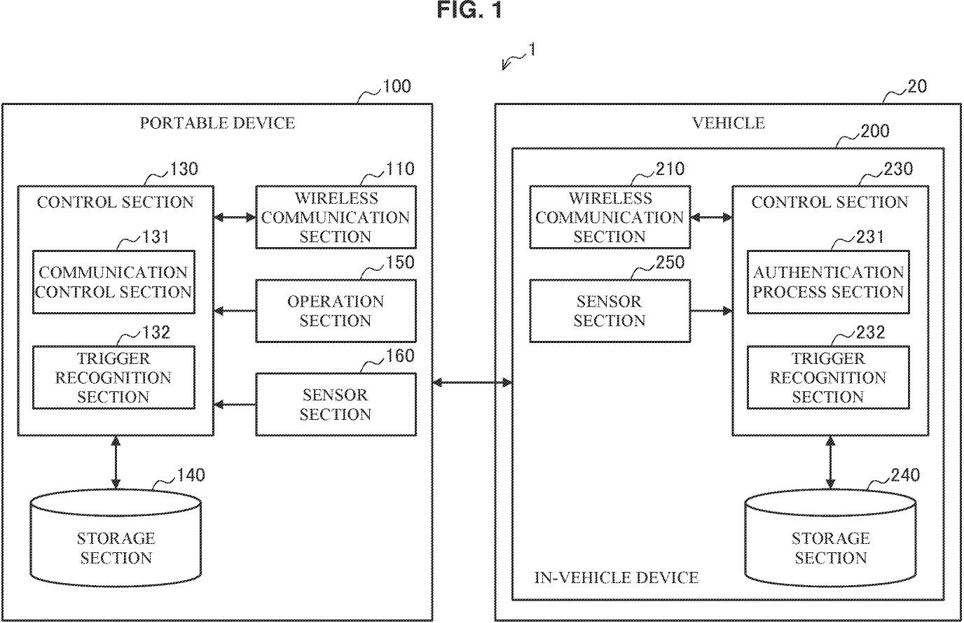

FIG. 1 is a diagram illustrating an example of a configuration of a system 1 according to an embodiment of the present invention. As illustrated in FIG. 1, the system 1 according to the present embodiment includes a portable device 100 and an in-vehicle device 200 installed in a vehicle 20. The vehicle 20 is an example of a mobile object that is a target (target object) to be used by a user.

A control device and another device (another control device) are involved in the present invention. The control device includes a control section configured to execute an authentication process of authenticating the other device by using information obtained through communication with the other device. The other device is an authenticatee. In the example illustrated in FIG. 1, the portable device 100 is an example of the other device (other control device), and the in-vehicle device 200 is an example of the control device.

For example, when a user who is a driver of the vehicle 20 approaches the vehicle 20 while carrying the portable device 100, the system 1 performs wireless communication for authentication between the portable device 100 and the in-vehicle device 200. Next, when the authentication succeeds, the vehicle 20 becomes available for the user by opening a door lock of the vehicle 20 and starting an engine of the vehicle 20 under the control of the in-vehicle device 200. Such a system 1 is also referred to as a smart entry system. Next, respective structural elements will be described sequentially.

### 1-1. Portable Device 100

The portable device 100 is configured as any control device to be carried and used by the user. Examples of the any control device include an electronic key, a smartphone, a wearable terminal, and the like. As illustrated in FIG. 1, the portable device (control device) 100 includes a wireless communication section 110, a control section 130, a storage section 140, an operation section 150, and a sensor section 160.

### Wireless Communication Section 110

The wireless communication section 110 has a function of performing communication with the in-vehicle device 200 in conformity with a predetermined wireless communication standard. For example, in accordance with the predetermined wireless communication standard, a radio frequency (RF) band signal and a low frequency (LF) band signal may be used. Alternatively, the signal may be transmitted as a Bluetooth Low Energy (BLE) (registered trademark) signal. Alternatively, an ultra-wideband (UWB) signal may be used. Note that, an impulse UWB signal has a property that makes it possible to perform ranging with high accuracy. In other words, it is possible for the impulse UWB signal to measure air propagation time of a radio wave with high accuracy by using the radio wave of ultrashort pulse width of nanoseconds or lower, and it is possible to perform ranging with high accuracy on the basis of the propagation time. Here, the ranging means measurement of a distance between devices that transmit and receive signals.

### Control Section 130

The control section 130 has a function of controlling overall behavior of the portable device 100. For example, the control section 130 controls the wireless communication section 110 to perform communication with the in-vehicle device 200. In addition, the control section 130 reads information from the storage section 140 and writes information into the storage section 140. For example, the control section 130 is implemented by an electronic circuit such as a microprocessor and a central processing unit (CPU).

The control section 130 also functions as an authentication control section that controls the authentication process between the in-vehicle device 200 and the portable device 100.

The authentication process may be request response authentication using a request signal and a response signal, for example. The request response authentication is a method in which an authenticator (for example, the in-vehicle device 200 according to the present embodiment) generates an authentication request signal and transmits the generated authentication request signal to an authenticatee (for example, the portable device 100 according to the present embodiment), the authenticatee generates an authentication response signal on the basis of the authentication request and transmits the generated authentication response signal to the authenticator, and the authenticator authenticates the authenticatee on the basis of the authentication response signal. The authentication request signal is a random number, and is changed with each authentication. Accordingly, the request response authentication is resistant to a replay attack. In addition, the authentication response signal is generated on the basis of the information regarding the authenticatee. For example, the information regarding the authenticatee is identification information (identifier, ID), a password, or the like for identifying the portable device 100. The ID and the password themselves are not transmitted/received. This makes it possible to reduce a possibility of eavesdropping. The request signal and the response signal maybe transmitted by using any frequency band. For example, the signals may be transmitted as the LF band signals, the RF band signals, the Bluetooth Low Energy (BLE) (registered trademark) signals, or the UWB signals.

In addition, the authentication process may be authentication based on a distance between the portable device 100 and the in-vehicle device 200. The authentication based on the distance includes a process of measuring the distance between the portable device 100 and the in-vehicle device 200, and a process of performing authentication on the basis of a result of measuring the distance.

In the former process (ranging process), for example, the portable device 100 transmits a first ranging signal, receives a second ranging signal transmitted as a response to the first ranging signal from the in-vehicle device 200 that has received the first ranging signal, and transmits a data signal. In addition, the in-vehicle device 200 receives the first ranging signal from the portable device 100 transmits the second ranging signal in response to the first ranging signal, and receives the data signal from the portable device 100 that has received the second ranging signal. The first ranging signal and the second ranging signal are transmitted as UWB signals, for example. This makes it possible to achieve high accuracy of ranging based on the UWB. In addition, the ranging signals do not include payload parts, and this makes it possible to prevent deterioration of sensitivity. On the other hand, the data signal may be transmitted as a RF/LF band signal. In the case where the RF/LF band signal is used for transmitting the data signal, it is possible to reduce deterioration of reception sensitivity in total and reduce electric power consumption by a receiver in comparison with a case where the UWB signal is used for transmitting the data signal.

The in-vehicle device 200 calculates the distance between the portable device 100 and the in-vehicle device 200 on the basis of the data signal received from the portable device 100. The data signal includes information indicating a time period ΔT1, which is a time period from time of transmission of the first ranging signal by the portable device 100 to time of reception of the second ranging signal by the portable device 100. The in-vehicle device 200 measures a time period ΔT2, which is a time period from time of reception of the first ranging signal to time of transmission of the second ranging signal, and calculates the distance between the portable device 10 and the in-vehicle device 200 on the basis of the measured time period ΔT2 and the time period ΔT1 indicated by the data signal. Specifically, time taken to transmit or receive a one-way signal is calculated by subtracting ΔT2 from ΔT1 and dividing the subtracted value by 2, and then the distance between the portable device 100 and the in-vehicle device 200 is calculated by multiplying the calculated time by speed of the signal.

In addition, in the latter process (authentication process) included in the above-described authentication based on the distance, the in-vehicle device 200 authenticates the portable device 100 on the basis of whether or not the measured distance satisfies a predetermined condition. For example, the in-vehicle device 200 determines that the authentication has succeeded if the measured distance is a predetermined value or less. If not, the in-vehicle device 200 determines that the authentication has failed.

Various kinds of signals used in the above-described authentication process may be transmitted in any frequency band.

In addition, the control section 130 according to the present embodiment also functions as a communication control section 131 and a trigger recognition section 132.

The communication control section 131 may perform control in such a manner that the portable device 100 enters a state where the wireless communication section 110 is capable of transmitting a predetermined signal for the authentication process (transmission mode) or a state where the wireless communication section 110 is capable of receiving the predetermined signal for the authentication process (reception mode). In other words, the communication control section 131 may perform “control for starting execution of the authentication process”. Note that, the state where the wireless communication section 110 is capable of receiving the signal is a state where the wireless communication section 110 executes a process of importing a received signal when the signal is received. Such a state is also referred to as a reception waiting state.

More specifically, the communication control section 131 performs control for starting execution of the authentication process using a predetermined frequency band in a case where the trigger recognition section 132 has recognized a predetermined trigger. The trigger recognition section 132 acquires the predetermined trigger when a predesignated operation is performed. For example, the storage section 140 stores information regarding the predesignated operation. The trigger recognition section 132 may acquire the predetermined trigger on the basis of information output from the operation section 150 or the sensor section 160. It is assumed that examples of the predetermined trigger include a user operation of double-clicking on the operation section 150, a user operation of shaking the portable device 100, and the like. The communication control section 131 may control the wireless communication section 110 in such a manner that the wireless communication section 110 enters a state capable of transmitting or receiving signals in the predetermined frequency band such as UWB in the case where the predetermined trigger is recognized. Note that, the predetermined frequency band is not limited to the UWB. The predetermined frequency band may be BLE or the RF/LF band.

### Storage Section 140

The storage section 140 has a function of storing various kinds of information for behavior of the portable device 100. For example, the storage section 140 stores a program for behavior of the portable device 100, and an identifier (ID), password, and authentication algorithm for authentication, etc. For example, the storage section 140 is implemented by a storage medium such as flash memory and a processing device that performs recording/playback on/of the storage medium.

### Operation Section 150 and Section 160

The operation section 150 and the sensor section 160 are examples of a reception section configured to receive the user operation that is the predetermined trigger. The portable device 100 may include both or one of the operation section 150 and the sensor section 160.

The operation section 150 has a function of receiving operations from the user. The operation section 150 may be implemented by a push-button switch that detects pressing force, a touch switch that detects touch, or the like, for example.

The sensor section 160 has a function of detecting motion of the portable device 100. For example, the sensor section 160 may be an acceleration sensor that detects acceleration, a gyro sensor that detects angular velocity, a geomagnetic sensor that detects a direction, a camera, or the like. In addition, the sensor section 160 may be a microphone that collects sound.

Details of the configuration example of the portable device 100 have been described above. Note that, the configuration illustrated in FIG. 1 is a mare example. The configuration of the portable device 100 is not limited thereto. For example, the portable device 100 does not have to include the sensor section 160.

### 1-2. In-Vehicle Device 200

The in-vehicle device 200 (control device) is assumed to be installed in the vehicle 20. For examples of the installation position, the in-vehicle device 200 may be installed in a vehicle interior of the vehicle 20, may be built in the vehicle 20 as a control module or a communication module, or may be installed in other ways.

As illustrated in FIG. 1, the in-vehicle device 200 includes a wireless communication section 210, a control section 230, a storage section 240, and a sensor section 250.

### Wireless Communication Section 210

The wireless communication section 210 has a function of performing communication with the portable device 100 in conformity with a predetermined wireless communication standard. The wireless communication section 210 is configured as a communication interface that makes it possible to perform communication by using UWB, BLE, or the RF/LF band, for example.

### Control Section 230

The control section 230 has a function of controlling overall behavior of the in-vehicle device 200. For example, the control section 230 controls the wireless communication section 210 to control communication with the portable device 100.

In addition, the control section 230 has a function of controlling behavior of the vehicle 20, or a function of approving the control over the behavior of the vehicle 20. Examples of the control over the behavior of the vehicle 20 include control over locking and unlocking of the door lock of the vehicle 20. In addition, the examples of the control over the behavior of the vehicle 20 include control over ON/OFF of lights installed in the vehicle 20. In addition, the examples of the control over the behavior of the vehicle 20 include control over start/stop of electric power distribution to predetermined electric parts installed in the vehicle 20. Examples of the “predetermined electronic parts” include an air conditioner, car audio equipment, car navigation equipment, and the like. In addition, the examples of the control over the behavior of the vehicle 20 include control over start/stop of the engine of the vehicle 20. In addition to or instead of the engine, a motor or the like may be installed as a driving source of the vehicle 20. For example, the control section 230 may be configured as an electronic control unit (ECU).

In addition, the control section 230 according to the present embodiment also functions as an authentication process section 231 and a trigger recognition section 232.

The authentication process section 231 controls the authentication process between the portable device 100 and the in-vehicle device 200. Details of the authentication process have already been described above. In addition, the authentication process section 231 may perform control in such a manner that the in-vehicle device 200 enters a state where the wireless communication section 210 is capable of transmitting a predetermined signal for the authentication process (transmission mode) or a state where the wireless communication section 210 is capable of receiving the predetermined signal for the authentication process (reception mode). In other words, the authentication process section 231 may perform “control for starting execution of the authentication process”. Note that, the state where the wireless communication section 210 is capable of receiving the signal is a state where the wireless communication section 210 executes a process of importing a received signal when the signal is received. Such a state is also referred to as a reception waiting state.

More specifically, the authentication process section 231 performs control for starting execution of the authentication process using a predetermined frequency band in a case where the trigger recognition section 232 has recognized a predetermined trigger. The trigger recognition section 232 acquires the predetermined trigger when a predesignated operation is performed. For example, the storage section 240 stores information regarding the predesignated operation. The trigger recognition section 232 may acquire the predetermined trigger on the basis of information output from the sensor section 250 installed in a door handle or the like of the vehicle 20, for example. It is assumed that examples of the predetermined trigger include a user operation of double-tapping the door handle, a user operation of long-touching the door handle, and the like. The authentication process section 231 may control the wireless communication section 210 in such a manner that the wireless communication section 110 enters a state capable of transmitting or receiving signals in the predetermined frequency band such as UWB in the case where the predetermined trigger is recognized. Note that, the predetermined frequency band is not limited to the UWB. The predetermined frequency band may be BLE or the RF/LF band.

### Storage Section 240

The storage section 240 has a function of storing various kinds of information for behavior of the in-vehicle device 200. For example, the storage section 240 stores a program for behavior of the in-vehicle device 200, an authentication algorithm, and the like. For example, the storage section 240 is implemented by a storage medium such as flash memory and a processing device that performs recording/playback on/of the storage medium.

### Sensor Section 250

The sensor section 250 is an example of the reception section configured to receive the user operation that is the predetermined trigger. The sensor section 250 has a function of detecting user operations performed on the vehicle 20. For example, the sensor section 250 may be a touch sensor that detects touch, a camera that detects motion of a body of the user, or a microphone that collects sound. The sensor section 250 may be installed near a door handle of a door of a driver’s seat of the vehicle 20, for example. Here, the sensor section 250 is used as an example of the reception section, but the reception section is not limited thereto. For example, the reception section may be the operation section such as the push-button switch that detects pressing force or the touch switch that detects touch.

Details of the configuration of the in-vehicle device 200 have been described above. The in-vehicle device 200 may be implemented by an electronic control unit (ECU) installed in the vehicle that is an example of the target to be used by the user. Note that, the device for implementing the in-vehicle device 200 is not necessarily limited to the ECU. For example, the in-vehicle device 200 may be implemented by a microcontroller or the like included in the ECU. Alternatively, the in-vehicle device 200 may be implemented by an external device (such as a cloud server, smartphone, a tablet terminal, or another vehicle, for example), which is not installed in the vehicle 20. In this case, the external device communicatively connects to an in-vehicle network of the vehicle 20, and transmits signals for control over behavior of the vehicle and signals for approving behavior of the vehicle to the control device installed in the vehicle 20.

In addition, the configuration of the in-vehicle device 200 illustrated in FIG. 1 is a mare example. The present embodiment is not limited thereto. For example, the in-vehicle device 200 may be implemented by a plurality of devices. For example, the wireless communication section 210 and the sensor section 250 may be installed in the vehicle 20 as separate objects from the in-vehicle device 200. In this case, the in-vehicle device 200 may connect to the wireless communication section 210 and the sensor section 250 through the in-vehicle communication network that meets any standard such as a Controller Area Network (CAN), a Local Interconnect Network (LIN), or a local area network (LAN).

### 2. Behavior Process Example

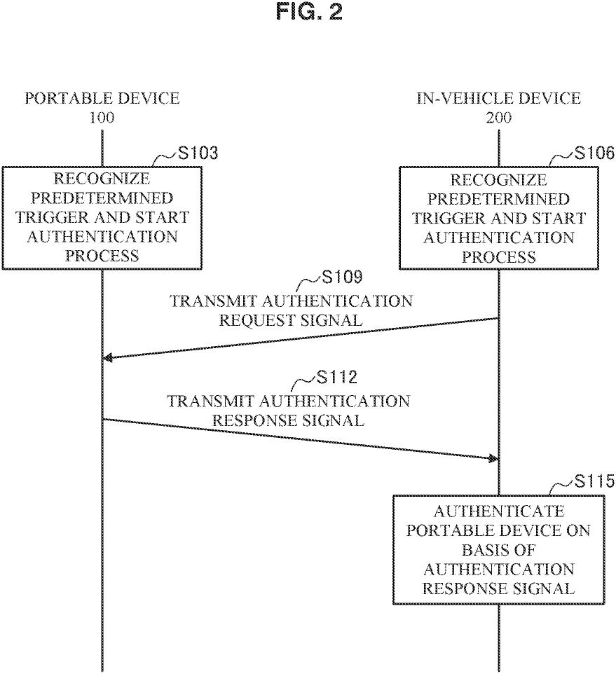

Next, details of the authentication process executed by the system 1 according to an embodiment of the present invention will be described with reference to FIG. 2. FIG. 2 is a sequence diagram illustrating an example of a flow of the authentication process executed by the system 1 according to the present embodiment. The portable device 100 and the in-vehicle device 200 are involved in this sequence.

As illustrated in FIG. 2, first, when the trigger recognition section 132 of the control section 130 of the portable device 100 recognizes the predetermined trigger, the communication control section 131 performs control for starting execution of the authentication process using a predetermined frequency band (Step S103). Here, for example, the communication control section 131 performs control in such a manner that the portable device 100 enters a state capable of receiving signals using the predetermined frequency band.

On the other hand, when the trigger recognition section 232 of the control section 230 of the in-vehicle device 200 recognizes the predetermined trigger, the authentication process section 231 performs control for starting execution of the authentication process using a predetermined frequency band (Step S106). Here, for example, the authentication process section 231 performs control in such a manner that the in-vehicle device 200 enters a state capable of transmitting signals using the predetermined frequency band.

Next, the authentication process section 231 of the in-vehicle device 200 transmits an authentication request signal by using the predetermined frequency band (Step S109). The authentication request signal is an example of a signal for authentication. For example, an LF band signal may be used in the predetermined frequency band.

Next, the communication control section 131 of the portable device 100 performs control in such a manner that an authentication response signal generated based on the authentication request signal is transmitted to the in-vehicle device 200 by using the predetermined frequency band (Step S112). For example, an RF band signal may be used in the predetermined frequency band.

Next, the authentication process section 231 of the in-vehicle device 200 authenticates the portable device 100 on the basis of the authentication response signal 231 (Step S115).

The above-described authentication process is a mere example, and the present embodiment is not limited thereto. For example, FIG. 2 illustrates the example of performing control in such a manner that the portable device 100 enters the reception mode when the predetermined trigger is recognized. However, the portable device 100 may enter the transmission mode. In this case, the in-vehicle device 200 is controlled in such a manner that the in-vehicle device 200 enters the reception mode when the predetermined trigger is recognized. Next, the communication control section 131 of the portable device 100 transmits authentication information by using the predetermined frequency band. For example, the authentication information is transmitted as the UWB signal. The authentication information may include information for authentication such as security information and pairing information. On the other hand, when the authentication process section 231 of the in-vehicle device 200 receives the authentication information from the portable device 100, the authentication process section 231 authenticates the portable device 100 on the basis of the received authentication information.

Note that, in the authentication process using the UWB, the authentication may be performed on the basis of the distance as described above. For example, in the case where the predetermined trigger is recognized, the communication control section 131 of the portable device 100 is controlled to enter the transmission mode, and transmits the first ranging signal by using the UWB. In this case, when the predetermined trigger is recognized, the in-vehicle device 200 is controlled to enter the reception mode and receives the first ranging signal transmitted from the portable device 100 by using the UWB. Next, when the first ranging signal is received, the in-vehicle device 200 transmits the second ranging signal to the portable device 100 in response to the first ranging signal. The second ranging signal is transmitted as the UWB signal, for example. Next, when the second ranging signal is received, the communication control section 131 of the portable device 100 measures the time period ΔT1 that is the time period from time of transmission of the first ranging signal to time of reception of the second ranging signal, and transmits a data signal to the in-vehicle device 200. The data signal includes information obtained by encrypting the information indicating the measured time period ΔT1. On the other hand, the authentication process section 231 of the in-vehicle device 200 measures the time period ΔT2 from time of reception of the first ranging signal to time of transmission of the second ranging signal. Next, the authentication process device 231 calculates the distance between the portable device 100 and the in-vehicle device 200 on the basis of the measured time period ΔT2 and the time period ΔT1 indicated by the data signal received from the portable device 100. Subsequently, the authentication process section 231 authenticates the portable device 100 on the basis of whether or not the measured distance satisfies a predetermined condition.

Alternatively, the authentication process performed in the case where the predetermined trigger is recognized may be an authentication process using BLE. For example, in the case where the predetermined trigger is recognized, the authentication process section 231 of the in-vehicle device 200 performs control in such a manner that an advertising signal (notification signal for notifying of presence of the in-vehicle device 200) is output to an outside by using BLE. On the other hand, the communication control section 131 of the portable device 100 performs control in such a manner that the portable device 100 enters a state capable of receiving BLE signals in the case where the predetermined trigger is recognized. Next, in response to reception of the advertising signal, the communication control section 131 performs control in such a manner that the authentication information including the security information and the pairing information is transmitted to the in-vehicle device 200 as the BLE signal, for example. Next, when the authentication information is received from the portable device 100, the authentication process section 231 of the in-vehicle device 200 authenticates the portable device 100 on the basis of the received authentication information.

As described above, the system 1 according to the present embodiment may start the authentication process between the devices by using the predetermined frequency band when the respective devices recognize the predetermined triggers. This makes it possible to establish communication between the devices more certainly, and reduce failure of the authentication due to due to unsuccessful establishment of the communication.

Note that, in the above-described example, the authentication process is started by using the predetermined frequency band in the case where both the portable device 100 and the in-vehicle device 200 has recognized the respective predetermined triggers. However, the present embodiment is not limited thereto. For example, one device may use a predetermined method to acquire information indicating that the other device has recognized the predetermined trigger. Here, the one device may be the portable device 100, and the other device may be the in-vehicle device 200. Conversely, the one device may be the in-vehicle device 200, and the other device may be the portable device 100. The acquisition by the predetermined method may be acquisition from the one device on a network via a server, direct acquisition from the one device through wireless communication or the like, or acquisition from monitoring equipment that monitors the situation of the one device, for example. The wireless communication may be communication using a same or different frequency band as or from the predetermined frequency band used for the authentication process. In addition, the monitoring equipment may be a separate device from the other device, or may be a structural element included in the other device. In addition, the monitoring equipment may be a sensor such as a microphone, a visible light communication section, or a camera, for example.

### 3. Application Example

Next, an application example of the present embodiment will be described. The above-described “control performed for starting execution of the authentication process by using the predetermined frequency band when the predetermined trigger is recognized” may be treated as an authentication process performed in a special case, which is different from the authentication process executed between the devices in normal use.

For example, normally, the authentication cannot be performed if the communication conforming to a first wireless communication standard is not established due to radio wave interference in a specific frequency band, in the case where a primary authentication process is performed in conformity with the first wireless communication standard and a secondary authentication process is performed in conformity with a second wireless communication standard, which is different from the first wireless communication standard. However, even in such a case, sometimes it is highly possible that communication can be established if the second wireless communication standard is used in a different frequency band.

In addition, in some circumstances, sometimes communication can be established in conformity with another wireless communication standard (second wireless communication standard) even if the communication cannot be established and the authentication cannot be performed in conformity with a normally used wireless communication standard (first wireless communication standard).

Accordingly, in this application example, it is possible to establish communication between the devices more certainly and reduce failure of the authentication due to due to unsuccessful establishment of the communication, by starting execution of the authentication process in conformity with a wireless communication standard different from a normally used wireless communication standard when the predetermined trigger is recognized. If the authentication has failed, the above-described smart entry system does not work appropriately. Therefore, the user has to take out a physical key and manually open the door lock. However, it is possible to reduce such inconveniences by reducing reduce failure of the authentication.

Next, details of the structural elements of a system 1a according to the present application example will be described sequentially.

### 3-1. Configuration Example

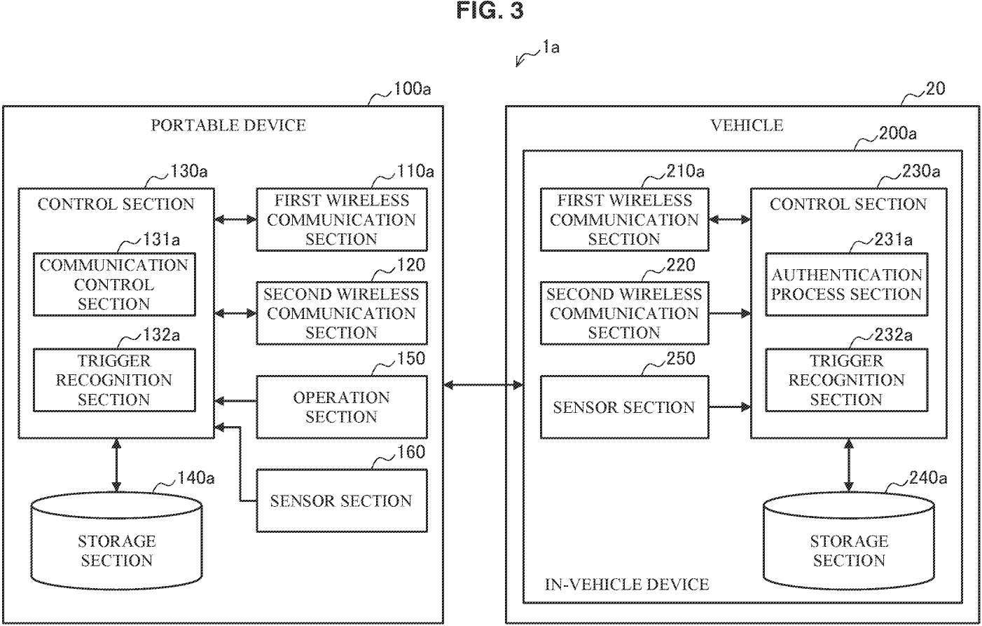

FIG. 3 is a diagram illustrating an example of a configuration of the system 1a according to the application example of the present invention. As illustrated in FIG. 3, the system 1a according to the present application example includes a portable device 100a and an in-vehicle device 200a installed in the vehicle 20.

### 31. Portable Device 100a

As illustrated in FIG. 3, the portable device 100a (control device) includes a first wireless communication section 110a, a second wireless communication section 120, a control section 130a, the storage section 140, the operation section 150, and the sensor section 160.

The first wireless communication section 110a has a function of performing communication with the in-vehicle device 200a in conformity with the first wireless communication standard. In this application example, the first wireless communication standard may be a wireless communication standard using a radio frequency (RF) band signal and a low frequency (LF) band signal.

The second wireless communication section 120 has a function of performing communication with the in-vehicle device 200a in conformity with the second wireless communication standard, which is different from the first wireless communication standard. In this application example, the second wireless communication standard may be a wireless communication standard using a UWB signal or a BLE signal.

The control section 130a has a function of controlling overall behavior of the portable device 100a. The control section 130a also functions as an authentication control section that controls an authentication process between the in-vehicle device 200a and the portable device 100a in a way similar to the control section 130 described above with reference to FIG. 1.

In addition, the control section 130a also functions as a communication control section 131a and a trigger recognition section 132a.

The communication control section 131a may perform control in such a manner that the portable device 100a enters a state where the first wireless communication section 110a or the second wireless communication section 120 is capable of transmitting a predetermined signal for the authentication process (transmission mode) or a state where the first wireless communication section 110a or the second wireless communication section 120 is capable of receiving the predetermined signal for the authentication process (reception mode). In other words, the communication control section 131a may perform “control for starting execution of the authentication process”. Note that , the state where the first wireless communication section 110a or the second wireless communication section 120 is capable of receiving the signal is a state where the first wireless communication section 110a or the second wireless communication section 120 executes a process of importing a received signal when the signal is received. Such a state is also referred to as a reception waiting state.

More specifically, the communication control section 131a controls start of the authentication process using the first wireless communication section 110a in normal cases (here, in the case where the predetermined trigger is not recognized). In the case where the predetermined trigger is recognized, the communication control section 131a controls start of the authentication process using the second wireless communication section 120. In normal cases, the request response authentication may be performed by using RF/LF band signals in the authentication process using the first wireless communication section 110a. In addition, in normal cases, the authentication process (request response authentication) using the first wireless communication section 110a may be performed as the primary authentication. If the authentication has succeeded, authentication based on a distance using the UWB signal may be performed as the authentication process using the second wireless communication section 120. It is possible to further enhance security by performing authentication based on the distance in addition to the request response authentication.

In addition, in the case where the predetermined trigger is recognized by the trigger recognition section 132a, the communication control section 131a may control start of the authentication process using the second wireless communication section 120 on the condition that the predetermined trigger is recognized after a normal authentication process has failed (communication is not established), or on the condition that the predetermined trigger is an operation different from a normal operation. Examples of the operation different from the normal operation include an operation (double tap) performed multiple times within a predetermined time period. In addition, examples of the normal operation include a press operation performed one time on a lock/unlock button installed on the portable device 100. In the case where the normal operation is performed, the communication control section 131a starts the normal authentication process using the first wireless communication section 110a.

The storage section 140a has a function of storing various kinds of information for behavior of the portable device 100a. For example, the storage section 140a stores a program for behavior of the portable device 100a, and an identifier (ID), password, and authentication algorithm for authentication, etc. For example, the storage section 140a is implemented by a storage medium such as flash memory and a processing device that performs recording/playback on/of the storage medium.

The operation section 150 and the sensor section 160 are examples of the reception section configured to receive the user operation that is the predetermined trigger. Details of the operation section 150 and the sensor section 160 are similar to the structural elements that are denoted with the same reference signs described above with reference to FIG. 1.

### 32. In-Vehicle Device 200a

As illustrated in FIG. 3, the in-vehicle device 200a (control device) includes a first wireless communication section 210a, a second wireless communication section 220, a control section 230a, a storage section 240a, and the sensor section 250.

The first wireless communication section 210a has a function of performing communication with the portable device 100a in conformity with the first wireless communication standard. In this application example, the first wireless communication standard may be the wireless communication standard using a radio frequency (RF) band signal and a low frequency (LF) band signal.

The second wireless communication section 220 has a function of performing communication with the portable device 100a in conformity with the second wireless communication standard, which is different from the first wireless communication standard. In this application example, the second wireless communication standard may be the wireless communication standard using a UWB signal or a BLE signal.

The control section 230a has a function of controlling overall behavior of the in-vehicle device 200. For example, the control section 230a controls the first wireless communication section 210a and the second wireless communication section 220 to control communication with the portable device 100, in a way similar to the control section 230 described above with reference to FIG. 1.

In addition, the control section 230a has a function of controlling behavior of the vehicle 20, or a function of approving the control over the behavior of the vehicle 20, in a way similar to the control section 230 described above with reference to FIG. 1. In addition, the control section 230a may be configured as an electronic control unit (ECU), for example.

In addition, the control section 230 according to the present embodiment also functions as an authentication process section 231a and a trigger recognition section 232a

The authentication process section 231a controls an authentication process between the portable device 100a and the in-vehicle device 200a. The authentication process section 231a may perform control in such a manner that the in-vehicle device 200a enters a state where the first wireless communication section 210a or the second wireless communication section 220 is capable of transmitting a predetermined signal for the authentication process (transmission mode) or a state where the first wireless communication section 210a or the second wireless communication section 220 is capable of receiving the predetermined signal for the authentication process (reception mode). In other words, the authentication process section 231a may perform “control for starting execution of the authentication process”. Note that, the state where the first wireless communication section 210a or the second wireless communication section 220 is capable of receiving the signal is a state where the first wireless communication section 210a or the second wireless communication section 220 executes a process of importing a received signal when the signal is received. Such a state is also referred to as a reception waiting state.

More specifically, the authentication process section 231a controls start of the authentication process using the first wireless communication section 210a in normal cases (here, in the case where the predetermined trigger is not recognized). In the case where the predetermined trigger is recognized, the authentication process section 231a controls start of the authentication process using the second wireless communication section 220. In normal cases, the request response authentication may be performed by using RF/LF band signals in the authentication process using the first wireless communication section 210a. In addition, in normal cases, the authentication process (request response authentication) using the first wireless communication section 210a may be performed as the primary authentication. If the authentication has succeeded, authentication based on a distance using the UWB signal may be performed as the authentication process using the second wireless communication section 220. It is possible to further enhance security by performing authentication based on the distance in addition to the request response authentication.

In addition, in the case where the predetermined trigger is recognized by the trigger recognition section 232a, the authentication process section 231a may control start of the authentication process using the second wireless communication section 220 on the condition that the predetermined trigger is recognized after a normal authentication process has failed (communication is not established), or on the condition that the predetermined trigger is an operation different from a normal operation. Examples of the operation different from the normal operation include an operation of touching the door handle of the vehicle 20 more than a predetermined time period, an operation (double tap) performed on the door handle multiple times within a predetermined time period, and other operations. In addition, examples of the normal operation include an operation performed on the door handle for opening or closing the door.

The storage section 240a has a function of storing various kinds of information for behavior of the in-vehicle device 200a. For example, the storage section 240a stores a program for behavior of the in-vehicle device 200a, an authentication algorithm, and the like. For example, the storage section 240a is implemented by a storage medium such as flash memory and a processing device that performs recording/playback on/of the storage medium.

The sensor section 250 is an example of the reception section configured to receive the user operation that is the predetermined trigger. Details of the sensor section 250 is similar to the structural element that is denoted with the same reference sign described above with reference to FIG. 1.

### 3-2. Behavior Process

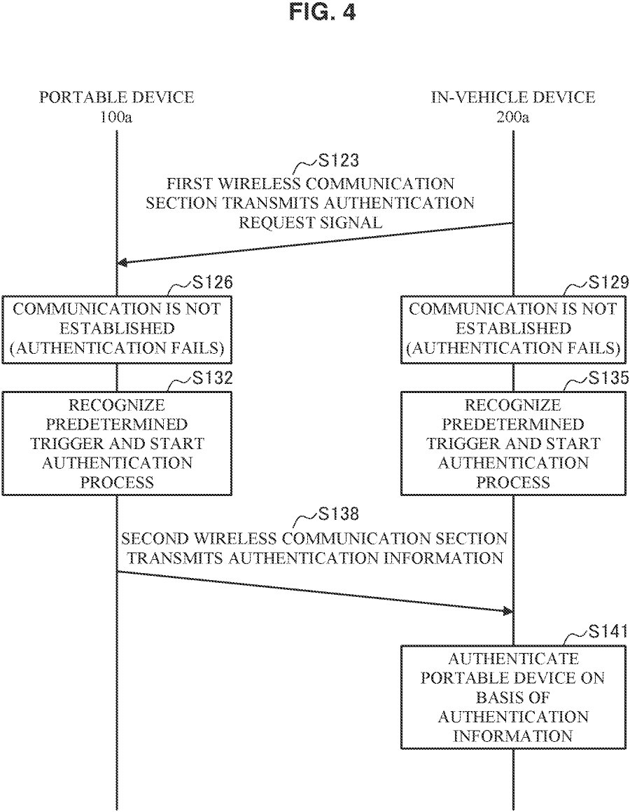

FIG. 4 is a sequence diagram illustrating an example of a flow of an authentication process executed by the system 1a according to the present application example. The portable device 100a and the in-vehicle device 200a are involved in this sequence. Here, for example, a behavior process performed on the condition that the normal authentication process has failed before the predetermined trigger is recognized, will be described.

As illustrated in FIG. 4, first, the normal authentication process using the first wireless communication sections is performed between the portable device 100a and the in-vehicle device 200a. Specifically, for example, the first wireless communication section 210a of the in-vehicle device 200a transmits an authentication request signal (Step S123). The authentication request signal is transmitted as an LF band signal, for example.

Next, the portable device 100a generates an authentication response signal on the basis of the authentication request signal, and returns the authentication response signal to the in-vehicle device 200a as an RF band signal, for example. However, if the radio wave interference occurs in the RF band, such communication cannot be established, and the authentication fails (Steps S126 and S129 129). Note that, here, the case where the radio wave interference occurs in the RF band has been described as an example, but the present application example is not limited thereto. The authentication also fails if the radio wave interference occurs in an LF band. In addition, in the normal authentication process, it is also considered that a wake-up signal for activating the portable device 100 may be transmitted by using the RF/LF bands before transmission of the authentication request signal. In this case, the portable device 100 returns a response signal in the RF/LF bands in response to the wake-up signal. However, in a similar way, the authentication also fails if the radio wave interference occurs in the RF/LF bands. Note that, examples of the response signal include an acknowledgment (ACK) signal that indicates activation, and a negative acknowledgement (NACK) signal that indicates non-activation.

Next, when the predetermined trigger is recognized, the portable device 100a and the in-vehicle device 200a controls start of an authentication process using the second wireless communication sections (Steps S132 and S135). Specifically, for example, the portable device 100a may control the first wireless communication section 210a in such a manner that the first wireless communication section 210a enters the transmission mode of UWB signals. On the other hand, the in-vehicle device 200a may control the second wireless communication section 220 in such a manner that the second wireless communication section 220 enters the reception mode of the UWB signals.

Next, the portable device 100a performs control in such a manner that the second wireless communication section 120 transmits authentication information to the in-vehicle device 200a as the UWB signal (Step S 138).

Next, the second wireless communication section 220 of the in-vehicle device 200a receives the authentication information that is the UWB signal, and the in-vehicle device 200a performs a process of authenticating the portable device 100a on the basis of the received authentication information (Step S141).

Note that, the authentication process using the UWB may be the above-described authentication based on a distance.

As described above, execution of the authentication process that is different from the normal authentication process is started in the case where the predetermined trigger is recognized after establishment of the normal wireless communication has failed. This makes it possible to successfully perform authentication.

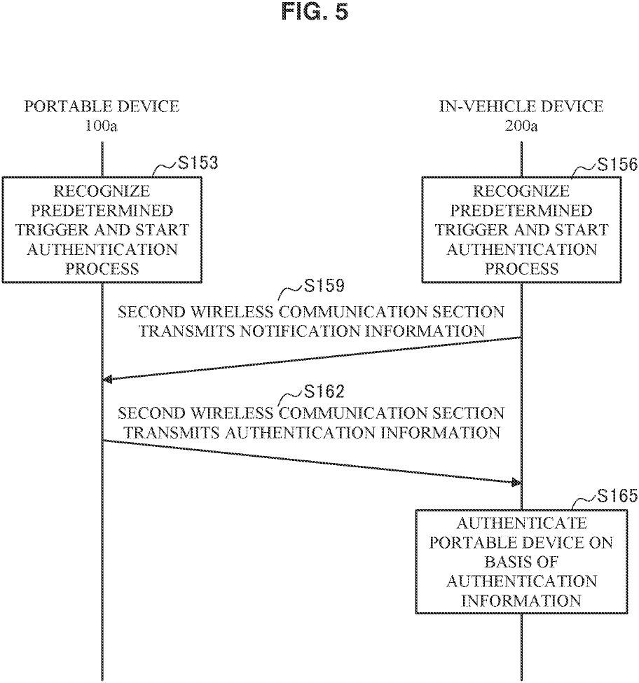

Note that, FIG. 4 illustrates the authentication process in which the UWB is used as the second wireless communication standard. However, the present application example is not limited thereto. For example, the authentication process may use BLE. Next, details thereof will be described with reference to FIG. 5.

FIG. 5 is a sequence diagram illustrating another example of the flow of the authentication process performed by the system according to the application example of the present invention.

As illustrated in FIG. 5, first, when the predetermined trigger is recognized, the second wireless communication section 120 of the portable device 100a starts execution of the authentication process (Step S153). Specifically, the portable device 100a is controlled to enter a mode of receiving BLE signals.

On the other hand, when the predetermined trigger is recognized, the second wireless communication section 220 of the in-vehicle device 200a starts execution of the authentication process (Step S156). Specifically, the in-vehicle device 200a is controlled to enter a mode of outputting notification information (advertising signal) to an outside by using BLE (Step S159).

Next, in response to reception of the notification information, the portable device 100a performs control in such a manner that the second wireless communication section 220 transmits the authentication information as a BLE signal (Step S162).

Next, the in-vehicle device 200a authenticates the portable device 100a on the basis of the received authentication information (Step S165).

### 4. Supplement

The case where the vehicle is used as an example of the mobile object has been mainly described above. However, the mobile object according to the present embodiment is not limited to the vehicle, and may be a ship (such as a passenger ship, a cargo ship, or a submarine) an aircraft (such as an airplane, a helicopter, a glider, or an airship), or the like. In addition, the vehicle is not limited to a car, and may be a bus, a motorcycle, a locomotive, an electric multiple unit, or the like. In addition, the mobile object is not necessarily limited to the above-described examples. Any object may be used as long as the object is movable. The in-vehicle device 200 and the in-vehicle device 200a that are installed in the mobile objects are mere examples. The in-vehicle devices 200 and 200a according to the present invention may be installed in anything other than the mobile object. For example, the control device corresponding to the in-vehicle device 200 or the in-vehicle device 200a may be installed in a parking lot for the vehicle 20. In this case, the control device may wirelessly transmit a control signal to the vehicle 20 on the basis of a result of communication with the portable device 100 or 100a and may remotely control the vehicle 20. Alternatively, at least some of the structural elements of the in-vehicle device 200 or 200a may be installed in the mobile object, and the other of the structural elements of the in-vehicle device 200 or 200a may be installed in anything other than the mobile object.

### 5 Conclusion

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

For example, although the example in which the authenticator (that is, the in-vehicle device 200 of the vehicle 20) transmits the first ranging signal has been described in the above embodiment, the present invention is not limited thereto. For example, it is also possible for the authenticatee (that is, the portable device 100) to transmit the first ranging signal. When the first ranging signal is received from the portable device 100, the in-vehicle device 200 transmits the second ranging signal in response to the first ranging signal. When the second ranging signal is received, the portable device 100 measures the time period ΔT1 that is a time period from transmission time of the first ranging signal to reception time of the second ranging signal. Next, the portable device 100 transmits a data signal including information obtained by encrypting information indicating the measured time period ΔT1. On the other hand, the in-vehicle device 200 measures the time period ΔT2 from reception time of the first ranging signal to transmission time of the second ranging signal. Next, when the data signal is received from the portable device 100, the in-vehicle device 200 calculates the distance between the portable device 100 and the in-vehicle device 200 on the basis of the measured time period ΔT2 and the time period ΔT1 indicated by the data signal received from the portable device 100. For example, time taken to transmit or receive a one-way signal is calculated by subtracting ΔT2 from ΔT1 and dividing the subtracted value by 2, and then the distance between the portable device 100 and the in-vehicle device 200 is calculated by multiplying the calculated time by speed of the signal. As described above, in the case where the directions of transmitting and receiving the first ranging signal and the second ranging signal are reversed, the in-vehicle device 200 performs control in such a manner that the in-vehicle device 200 transitions to the reception mode of waiting for the first ranging signal transmitted from the portable device 100 when the predetermined trigger is recognized. On the other hand, the portable device 100 performs control in such a manner that the portable device 100 transitions to the transmission mode of transmitting the first ranging signal when the predetermined trigger is recognized.

In addition, although the example in which the portable device 100 serves as the authenticatee and the in-vehicle device 200 serves as the authenticator has been described in the above embodiment, the present invention is not limited thereto. The roles of the portable device 100 and the in-vehicle device 200 may be reversed, or the roles may be switched dynamically. In addition, the ranging and the authentication may be performed between the in-vehicle devices 200.

In addition, for example, although the example in which the present invention is applied to the smart entry system has been described in the above embodiment, the present invention is not limited thereto. The present invention is applicable to any system that performs the ranging and authentication by transmitting/receiving signals. Examples of the target to be used by the user include a drone, a vehicle, a ship, an airplane, a building (such as house), a robot, a locker, a home appliance, and the like. In addition, the present invention is applicable to a pair of any two devices selected from a group including portable devices, vehicles, ships, airplanes, smartphones, drones, buildings, robots, lockers, home appliances, and the like. Note that, the pair may include two device of a same type, or may include two devices of different types. In this case, one of the devices behaves as the authenticator device and the other device behaves as the authenticatee device.

Note that, the series of processes performed by the devices described in this specification may be achieved by any of software, hardware, and a combination of software and hardware. A program that configures the software is stored in advance in, for example, a recording medium (non-transitory medium) installed inside or outside the devices. In addition, for example, when a computer executes the programs, the programs are read into RAM, and executed by a processor such as a CPU. The recording medium may be a magnetic disk, an optical disc, a magnetooptical disc, flash memory, or the like, for example. Alternatively, the above-described computer program may be distributed via a network without using the recording medium, for example.

Further, in the present specification, the processes described using the sequence diagrams are not necessarily executed in the order illustrated in the drawings. Some processing steps may be executed in parallel. In addition, additional processing steps may be employed and some processing steps may be omitted.

In addition, the effects described herein are illustrative or exemplary but not limitative. In other words, the technology according to the present disclosure can exhibit other effects that are evident to those skilled in the art along with or instead of the effects based on the present specification.

### Reference Signs List

100 portable device
110 wireless communication section
130 control section
131 communication control section
132 trigger recognition section
140 storage section
150 operation section
160 sensor section
20 vehicle
200 in-vehicle device
210 wireless communication section
230 control section
231 authentication process section
232 trigger recognition section
240 storage section
250 sensor section
100a portable device
110a first wireless communication section
120 second wireless communication section
130a control section
131a communication control section
132a trigger recognition section
140a storage section
200a in-vehicle device
210a first wireless communication section
220 second wireless communication section
230a control section
231a authentication process section
232a trigger recognition section
240a storage section

1. A control device comprising
a control section configured to execute an authentication process of authenticating another device on a basis of information for authentication acquired from the other device,
wherein, the control section starts the execution of the authentication process in a case where a predetermined trigger is acquired.

2. The control device according to claim 1, further comprising
a wireless communication section configured to acquire information from the other device through wireless communication.

3. The control device according to claim 2,
wherein the control section acquires the predetermined trigger that is a designated operation performed on the other device.

4. The control device according to claim 3,
wherein the control section acquires the predetermined trigger from the other device via the wireless communication section.

5. The control device according to claim 2,
wherein the control section acquires the predetermined trigger that is a designated operation performed on a casing in which the control device is installed.

6. The control device according to claim 2,
wherein, as a part of the authentication process, the control section starts causing the control device to enter a reception mode capable of receiving and processing information transmitted from the other device via the wireless communication section, in a case where the predetermined trigger is received.

7. The control device according to claim 6,
wherein, as a part of the authentication process, the control section performs ranging for measuring a distance to the other device and performs authentication based on the measured distance.

8. The control device according to claim 2,
wherein, as a part of the authentication process, the control section starts causing the control device to enter an output mode capable of outputting notification information to an outside via the wireless communication section in a case where the predetermined trigger is received, the notification information being information for notifying of presence of the control device.

9. The control device according to claim 8,
wherein, as a part of the authentication process, the control section performs authentication based on the information for authentication received from the other device that has acquired the notification information.

10. (canceled)

11. (canceled)

12. The control device according to claim 2,
wherein the control section acquires the predetermined trigger that is a designated operation different from an operation for starting the authentication through predetermined wireless communication.

13. The control device according to claim 12,
wherein the control section performs control in such a manner that the execution of the authentication process is started through wireless communication conforming to a second wireless communication standard that is different from a first wireless communication standard, in a case where the control section acquires the predetermined trigger that is a designated operation different from a normal operation for starting the authentication through the predetermined wireless communication conforming to the first wireless communication standard.

14. (canceled)

15. A control device comprising
a control section configured to perform control in such a manner that information to be used by another device to perform authentication is output to the other device,
wherein, in a case where a predetermined trigger is acquired, the control section performs control in such a manner that the information is output to the other device that starts execution of an authentication process of authenticating the control device.

16. The control device according to claim 15, further comprising
a wireless communication section configured to transmit the information to the other device through wireless communication.

17. The control device according to claim 16,
wherein the control section outputs the predetermined trigger to the other device via the wireless communication section, the predetermined trigger being a designated operation performed on the control device.

18. The control device according to claim 17,
wherein, in a case where the designated operation is performed on the control device, the control section causes the control device to enter a transmission mode capable of transmitting the information to the other device via the wireless communication section.

19. (canceled)

20. The control device according to claim 16,
wherein the control section outputs the information in a case where notification information for notifying of presence of the other device is received from the other device that has acquired the predetermined trigger.

21. The control device according to claim 17,
wherein the control section outputs the information in a case where the predetermined trigger is acquired after establishment of predetermined wireless communication has failed.

22. The control device according to claim 21,
wherein, the control section performs control in such a manner that the information is output through wireless communication conforming to a second wireless communication standard that is different from a first wireless communication standard, in a case where the predetermined trigger is acquired after establishment of the predetermined wireless communication conforming to the first wireless communication standard has failed.

23. The control device according to claim 17,
wherein the control section acquires the predetermined trigger that is a designated operation different from an operation for starting the authentication through predetermined wireless communication.

24. (canceled)

25. (canceled)

26. A control method comprising
causing a processor to execute an authentication process of authenticating another device on a basis of information for authentication acquired from the other device,
wherein the execution of the authentication process is started in a case where a predetermined trigger is acquired.

27. (canceled)
